(19) United States
(12) Patent Application Publication
(10) Pub. No.: US 2026/0046065 A1
(43) Pub. Date: Feb. 12, 2026

(54) WIRELESS PACKET VALIDATION AND CORRECTION

(71) Applicant: Synaptics Incorporated, San Jose, CA (US)

(72) Inventors: Venkateswaran Narayanan, Bangalore (IN); Vaibhav Dutta, Bangalore (IN)

(73) Assignee: Synaptics Incorporated, San Jose, CA (US)

(21) Appl. No.: 18/799,727

(22) Filed: Aug. 9, 2024

(51) Int. Cl. H04L 1/00; H04W 84/12

(52) U.S. Cl. CPC H04L 1/0083; H04L 1/0061; H04W 84/12

(57) ABSTRACT

This disclosure provides implementations for receiving and processing packets in a wireless local area network (WLAN). A WLAN device (such as a station or access point) may replace content in a received packet with predetermined content based on the received packet failing a frame check sequence (FCS), and the WLAN device may attempt to process the packet. In this manner, the WLAN device may not need to wait for a new packet, and the transmitting device may not need to retransmit the packet. In some aspects, the WLAN device stores a first content of a first packet. The first packet may include a mask or table indicating the fields to be replaced in a received frame and the content to include in those fields. The first packet may be generated from known settings of the WLAN or transmitting device or may be generated from a previously received packet.

### TECHNICAL FIELD

The present implementations relate generally to wireless packet validation and correction, and specifically to the correction of a wireless local area network (WLAN) packet based on a failed frame check sequence (FCS) for the WLAN packet.

### BACKGROUND OF RELATED ART

A wireless local area network (WLAN) of a plurality of wireless devices includes one or more wireless access points (APs) that provide a shared wireless communication medium for one or more wireless stations (STAs). The WLAN and its constituent WLAN devices conform to the Institute of Electrical and Electronics Engineers (IEEE) 802.11 family of standards and/or the Wi-Fi Alliance family of standards. A WLAN may include a Basic Service Set (BSS) managed by an AP, with each BSS being identified by a Basic Service Set Identifier (BSSID) that is advertised by the AP. An AP periodically broadcasts beacon frames to enable any STAs within wireless range of the AP to establish or maintain a communication link to the AP and thus with the WLAN. A STA and an AP may transmit wireless packets between each other. Additionally or alternatively, a WLAN may include an independent basic service set (IBSS), which is also referred to as an ad-hoc network, or other peer to peer (P2P) networks in which two STAs may transmit packets directly with each other over a direct communication link. A WLAN may also have two APs transmitting packets with each other, such as in a mesh network.

Successfully receiving a wireless packet depends on a plurality of factors. Such factors may include the distance between the wireless devices transmitting wireless packets between each other, the existence of physical objects that a wireless packet must pass through or reflect around in traveling between wireless devices, the transmit power at which the wireless packet is transmitted, and interference by other devices transmitting on the same wireless communication medium (such as other WLAN devices) or emitting energy at or near the same frequency as the wireless packet (such as emissions from a microwave oven interfering with a wireless packet in the 2.4 gigahertz (GHz) frequency band). As such, there is a need to improve the ability to successfully receive and process a wireless packet in light of all of the factors that reduce the likelihood of receiving and processing the wireless packet.

### SUMMARY

This Summary is provided to introduce in a simplified form a selection of concepts that are further described below in the Detailed Description. This Summary is not intended to identify key features or essential features of the claimed subject matter, nor is it intended to limit the scope of the claimed subject matter.

One innovative aspect of the subject matter of this disclosure can be implemented in a method performed by a wireless local area network (WLAN) device. The method includes storing, in a memory of a WLAN device, a first content of a first WLAN packet. The method also includes receiving, by a WLAN interface of the WLAN device, a second WLAN packet transmitted by a transmitting device. The second WLAN packet includes a second content. The method further includes generating a third WLAN packet by replacing at least a portion of the second content of the second WLAN packet with a corresponding at least portion of the first content of the first WLAN packet as stored in the memory of the WLAN device. The method also includes processing the third WLAN packet.

Another innovative aspect of the subject matter of this disclosure can be implemented in a WLAN device, including a wireless interface, a processing system, and a memory. The memory stores instructions that, when executed by the processing system, cause the WLAN device to perform operations. The operations include storing, in the memory, a first content of a first WLAN packet. The operations also include receiving, by the WLAN interface, a second WLAN packet transmitted by a transmitting device. The second WLAN packet includes a second content. The operations further include generating a third WLAN packet by replacing at least a portion of the second content of the second WLAN packet with a corresponding at least portion of the first content of the first WLAN packet as stored in the memory of the WLAN device. The operations also include processing the third WLAN packet.

In some aspects, the WLAN device also identifies whether the second WLAN packet is corrupted, with generating the third WLAN packet being based on identifying that the second WLAN packet is corrupted.

Identifying whether the second WLAN packet is corrupted may include performing a frame check sequence (FCS) on the second WLAN packet. In some aspects of replacing at least the portion of the second content of the second WLAN packet with the corresponding at least portion of the first content of the first WLAN packet, the WLAN device may replace content of one or more second fields of the second WLAN packet with content of corresponding one or more first fields of the first WLAN packet. The one or more second fields are defined to be replaced at the WLAN device.

### BRIEF DESCRIPTION OF THE DRAWINGS

The present implementations are illustrated by way of example and are not intended to be limited by the figures of the accompanying drawings.

FIG. 1 shows an example wireless local area network (WLAN) packet at the physical layer (PHY).

FIG. 2 shows an example media access control layer (MAC) frame format of a data frame or a management frame of a WLAN packet.

FIG. 3 shows an example MAC frame format of a request to send (RTS) frame and a clear to send (CTS) or acknowledgement (ACK) frame of a WLAN packet.

FIG. 4 shows an example MAC frame format of a beacon frame of a WLAN packet.

FIG. 5 shows an example MAC frame format of a probe request frame of a WLAN packet.

FIG. 6 shows an example MAC frame format of a probe response frame of a WLAN packet.

FIG. 7 shows a block diagram of an example WLAN device, according to some implementations.

FIG. 8 shows an illustrative flowchart depicting an example operation for replacing a portion of a WLAN packet, according to some implementations.

FIG. 9 shows an illustrative flowchart depicting an example operation for identifying and correcting a corrupted WLAN packet, according to some implementations.

### DETAILED DESCRIPTION

In the following description, numerous specific details are set forth such as examples of specific components, circuits, and processes to provide a thorough understanding of the present disclosure. The term “coupled” as used herein means connected directly to or connected through one or more intervening components or circuits. The terms “electronic system” and “electronic device” may be used interchangeably to refer to any system capable of electronically processing information. Also, in the following description and for purposes of explanation, specific nomenclature is set forth to provide a thorough understanding of the aspects of the disclosure. However, it will be apparent to one skilled in the art that these specific details may not be required to practice the example embodiments. In other instances, well-known circuits and devices are shown in block diagram form to avoid obscuring the present disclosure. Some portions of the detailed descriptions which follow are presented in terms of procedures, logic blocks, processing and other symbolic representations of operations on data bits within a computer memory.

These descriptions and representations are the means used by those skilled in the data processing arts to most effectively convey the substance of their work to others skilled in the art. In the present disclosure, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a computer system. It should be borne in mind, however, that all of these and similar terms are to be associated with the appropriate physical quantities and are merely convenient labels applied to these quantities.

Unless specifically stated otherwise as apparent from the following discussions, it is appreciated that throughout the present application, discussions utilizing the terms such as “accessing,” “receiving,” “sending,” “using,” “selecting,” “determining,” “normalizing,” “multiplying,” “averaging,” “monitoring,” “comparing,” “applying,” “updating,” “measuring,” “deriving” or the like, refer to the actions and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

In the figures, a single block may be described as performing a function or functions; however, in actual practice, the function or functions performed by that block may be performed in a single component or across multiple components, and/or may be performed using hardware, using software, or using a combination of hardware and software. To clearly illustrate this interchangeability of hardware and software, various illustrative components, blocks, modules, circuits, and steps have been described below generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the example input devices may include components other than those shown, including well-known components such as a processor, memory and the like.

The techniques described herein may be implemented in hardware, software, firmware, or any combination thereof, unless specifically described as being implemented in a specific manner. Any features described as modules or components may also be implemented together in an integrated logic device or separately as discrete but interoperable logic devices. If implemented in software, the techniques may be realized at least in part by a non-transitory processor-readable storage medium including instructions that, when executed, performs one or more of the methods described above. The non-transitory processor-readable data storage medium may form part of a computer program product, which may include packaging materials.

The non-transitory processor-readable storage medium may comprise random access memory (RAM) such as synchronous dynamic random-access memory (SDRAM), read only memory (ROM), non-volatile random access memory (NVRAM), electrically erasable programmable read-only memory (EEPROM), FLASH memory, other known storage media, and the like. The techniques additionally, or alternatively, may be realized at least in part by a processor-readable communication medium that carries or communicates code in the form of instructions or data structures and that can be accessed, read, and/or executed by a computer or other processor.

The various illustrative logical blocks, modules, circuits and instructions described in connection with the embodiments disclosed herein may be executed by one or more processors (or a processing system). The term “processor” as used herein may refer to any general-purpose processor, special-purpose processor, conventional processor, controller, microcontroller, and/or state machine capable of executing scripts or instructions of one or more software programs stored in memory.

A wireless local area network (WLAN) includes a plurality of wireless devices (also referred to as WLAN devices) communicating with one another over a wireless medium (such as over one or more wireless channels in the 2.4 gigahertz (GHz), 5 GHz, or 6 GHz frequency spectrum). As noted above, the WLAN and the WLAN devices comply with the IEEE 802.11 family of standards and/or the Wi-Fi Alliance family of standards. For example, a WLAN device may comply with IEEE 802.11b or g to communicate in the 2.4 GHz frequency band or the IEEE 802.11n, ac, ax, or other standards to communicate in the 5 GHz frequency band. To note, other frequency bands may also be used for communication now or in the future by WLAN devices (such as the 900 MHz frequency band, the 6 GHz frequency band, or the 60 GHz frequency band), and the operations described herein may apply to communications complying with current or future standards from the IEEE 802.11 family of standards or the Wi-Fi Alliance family of standards.

To communicate from one WLAN device to another, a transmitting device transmits a wireless packet (also referred to herein as a WLAN packet) to a receiving device. The receiving device receives the WLAN packet at a physical layer (PHY) of the device, such as at a modem, and decodes the WLAN packet to obtain the media access control layer (MAC) frame of the WLAN packet. The MAC frame is then processed, such as obtaining the data encapsulated in the frame body, at the MAC of the WLAN device (such as a processor). As used herein, processing a WLAN packet refers to processing the MAC frame at the MAC or a higher layer after decoding the WLAN packet at the PHY.

In order to be able to process the WLAN packet, the receiving device determines if the WLAN packet is corrupted. For example, the WLAN packet includes a frame check summary (FCS) field that includes a sequence of bits representing an FCS number used by the receiving device to identify if the WLAN packet is corrupted. To identify whether the WLAN packet is corrupted, the receiving device performs FCS on the WLAN packet. For example, the receiving device performs a cyclic redundancy check (CRC) by computing a checksum from the MAC frame using a CRC polynomial, with the transmitting device also using the same CRC polynomial to generate an FCS number from the MAC frame to be transmitted and including the FCS number in the FCS field. The receiving device thus identifies that a received WLAN packet is corrupted if the FCS number in the FCS field does not match the checksum generated by the receiving device using the CRC polynomial.

Typically, a receiving device discards a WLAN packet identified as corrupted and waits to receive a new WLAN packet from the transmitting device. In an example wherein the WLAN packet is a data packet, if the data packet is corrupted, the receiving device discards the data packet and does not send an acknowledgement (ACK) to the transmitting device to indicate that the data packet was successfully received. Alternatively, the receiving device may transmit a block ACK (BA) to the transmitting device indicating that a specific frame (also referred to as a protocol data unit (PDU)) was not successfully received. The transmitting device thus retransmits the data packet to the receiving device, with the receiving device waiting in an active state to receive the retransmitted data packet. In another example wherein the WLAN packet being a beacon, if the beacon is corrupted, the receiving device waits the beacon interval (BI) until the next beacon is to be transmitted.

One problem with waiting for a WLAN packet to be retransmitted is that the receiving device must remain in the active state and cannot enter a power save (PS) state. Typically, a WLAN device enters a PS state when the WLAN device is not to receive any more packets (such as for the remainder of a beacon interval). For a PS state, the WLAN device may place the modem, a radio, and one or more antennas into a low power mode (thus not performing carrier sensing to receive new packets during that time). However, if the WLAN packet is not successfully received, the WLAN device remains in an active state (such as for the remainder of the beacon interval) until the retransmitted WLAN packet is successfully received. As a result, additional power and processing resources are consumed by the WLAN device by remaining in an active state.

Another problem with waiting for a WLAN packet to be retransmitted is that retransmission of the WLAN packet takes time. For example, if the corrupted WLAN packet received at a station (STA) includes a beacon frame from an access point (AP), the STA waits until the end of the beacon interval to receive the next beacon frame. If the corrupted WLAN packet is a data packet, the receiving device waits for an interval during which the transmitting device listens for an ACK plus an interval at which the transmitting device retransmits the data packet. As a result, time is consumed waiting for the new WLAN packet, which may be of particular importance for latency critical applications (such as audio or video teleconferencing or live streaming), synchronization with an AP, or receiving of data already queued for transmission at an AP.

A further problem is that the transmitting device may be required to retransmit the WLAN packet. In addition, the transmitting device may change the modulation coding scheme (MCS) to decrease the throughput and/or may increase the transmit power to attempt to increase the likelihood that the receiving device successfully receives the WLAN packet. The transmitting device retransmitting the WLAN packet, and especially as a result of decreasing throughput or increasing transmit power to retransmit the WLAN packet, causes the transmitting device to consume additional power, processing resources, and time.

Aspects of the present disclosure relate to wireless packet validation and corrections, and more particularly, to correcting corrupted WLAN packets and processing the corrected WLAN packets instead of discarding such packets. In some aspects, a WLAN device stores in memory a first content of a first WLAN packet. For example, content of one or more fields of a MAC frame as defined at the WLAN device are stored in the memory. The first WLAN packet may be generated from a previously received packet or from one or more settings of the device or of the WLAN (such as of a transmitting device). The WLAN device thus receives a second WLAN packet from a transmitting device, generates a third WLAN packet by replacing at least a portion of the second WLAN packet with the first content of the first WLAN packet, and processes the third WLAN packet. Generating the third WLAN packet may be based on the WLAN device identifying that the second WLAN packet is corrupted (such as by performing FCS using the FCS field of the MAC frame of the second WLAN packet). In this manner, the WLAN device attempts to correct a corrupted WLAN packet before discarding the corrupted WLAN packet altogether, which may save processing and power resources at the receiving device and the transmitting device as well as time.

In some implementations, replacing a portion of content of a WLAN packet includes replacing the content in one or more fields of the WLAN packet with predefined content. In particular, one or more fields of a MAC frame of an incoming WLAN packet have their content replaced with defined content of one or more fields of a MAC frame stored at a system to process the incoming WLAN packet (which is also referred to as replacing fields with fields). For example, a WLAN device may store in memory a WLAN packet that includes the fields and their content to be used to replace the content of corresponding fields of an incoming packet (which is also referred to herein as a template WLAN packet or stored WLAN packet). To note, storing a template WLAN packet may include storing a template MAC frame that includes the fields that are to be used for content replacement. The system may use the template WLAN packet as a mask, with missing fields (or fields with missing content) from the template WLAN packet indicating that the corresponding fields of the incoming WLAN packet whose content may remain as-is. Conversely, fields in the template WLAN packet with predefined content indicate the corresponding fields of an incoming WLAN packet whose content may be replaced. In some other implementations, the stored WLAN packet may include a table of fields, with the table organized such that the WLAN device is able to identify the fields to be replaced in the second WLAN packet and the table including cells whose values are the content used to replace the field in the second WLAN packet.

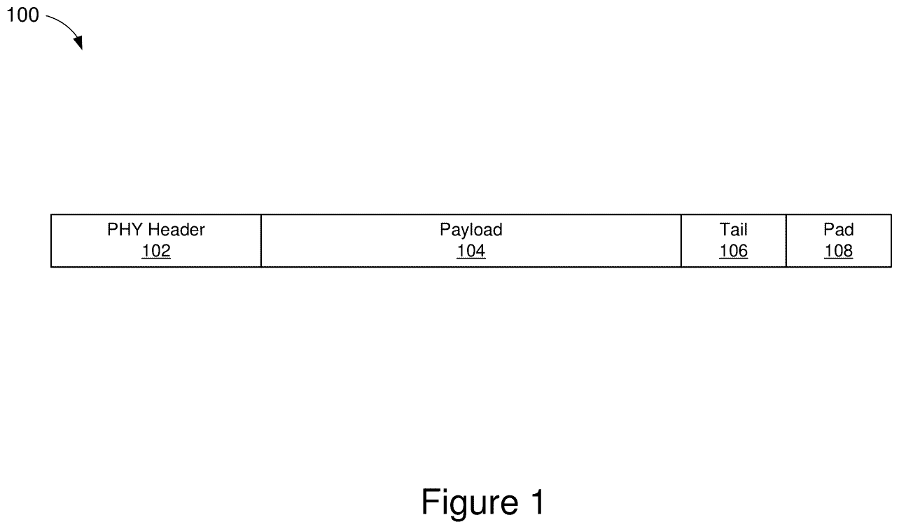

FIG. 1 through FIG. 6 depict example formats of a WLAN packet and different example MAC frames that may be included in a WLAN packet. The examples are depicted to show different portions of the WLAN packet (such as fields of the MAC frame) that may be replaced using the current implementations described herein.

FIG. 1 shows an example WLAN packet 100 at the physical layer (PHY). The example WLAN packet 100 includes a PHY header 102, a payload 104, a tail 106, and a padding 108. WLAN packets that conform to the IEEE 802.11 library of standards and the Wi-Fi Alliance standards typically are in the format of the WLAN packet 100.

The PHY header 102 (which may also be referred to as a Physical Link Convergence Protocol (PLCP) header) may include various fields based on the IEEE 802.11 standard, such as one or more of a short training field (STF) (which may be a legacy STF (L-STF)), a high throughput (HT) STF (HT-STF), a very high throughput (VHT) STF (VHT-STF), a long training field (LTF) (which may be a legacy LTF (L-LTF)), an HT-LTF, a VHT-LTF, a signal field (SIG) (such as a legacy SIG (L-SIG)), an HT-SIG, or a VHT-SIG. For some WLAN packets, the PHY header 102 may include a separate preamble and header portion.

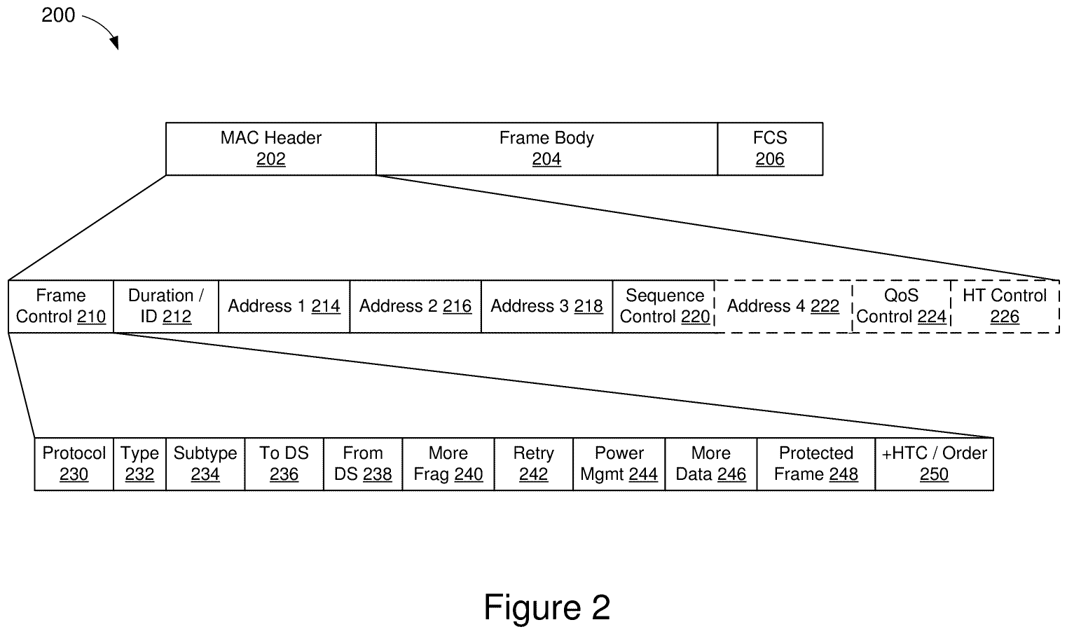

The payload 104 includes the data provided by the MAC (which may also be referred to as a data link layer (DLL)) of a transmitting device to the PHY of the transmitting device to be enveloped and encoded at the PHY for delivery to another device. The payload 104 includes one or more MAC frames, with a MAC frame including a MAC header and data provided to the MAC by a layer above the MAC of the transmitting device, such as depicted in FIG. 2 through FIG. 6 and described below. As such, a MAC frame in a format depicted in one of FIG. 2 through FIG. 6 may be included in the payload 104.

The tail 106 includes bits used for clearing a decoder of a modem of a receiving WLAN device after the WLAN device decodes the WLAN packet 100. The padding 108 includes bits to ensure that the size of the WLAN packet is an integer number of symbols (with a symbol size based on the connection between a transmitting device and a receiving device). To note, the WLAN packet 100 is but one example format of a WLAN packet at the PHY, and other WLAN packet formats may be used. For example, while not depicted in FIG. 1, a WLAN packet may include a beamforming training field (BTF) if beamforming is used.

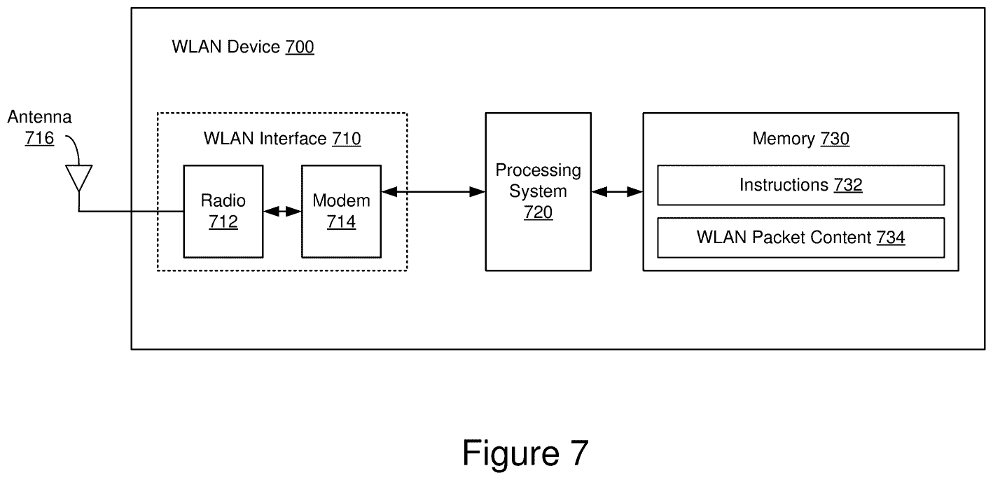

As described in more detail below with reference to FIG. 7, a WLAN device uses the PHY header 102 to decode the WLAN packet 100 and obtain the payload 104. As noted above, the payload 104 includes one or more MAC frames to be processed. MAC frames may be of various formats based on the function of the MAC frame. For example, the different functions for which a MAC frame may be formatted include transmitting data (through the use of a MAC data frame) or transmitting control or management information (through the use of a MAC management or control frame), such as requesting permission to send information to another WLAN device (through the use of a request-to-send (RTS) MAC frame), indicating to a transmitting device that it is cleared to send (through the use of a clear-to-send (CTS) MAC frame), indicating that a transmitted packet was successfully received (through the use of an acknowledgement (ACK) MAC frame), and broadcasting the existence of and information regarding a BSS as well as other information regarding the BSS (through the use of a beacon MAC frame).

FIG. 2 shows an example MAC frame format 200 (referred to simply as a MAC frame) of a data frame or a management frame of a WLAN packet. The MAC frame 200 may be included in the payload 104 of the WLAN packet 100. The MAC frame 200 includes a MAC header 202, a frame body 204, and a frame check sequence (FCS) 206. As can be seen in comparing the different MAC frames depicted in FIG. 2 through FIG. 6, the MAC headers and frame bodies across the different MAC frames and for a MAC frame itself may include different formatting based on the function to be performed and the IEEE 802.11 standard to which the MAC frame complies. To note, the dashed boxes throughout the Figures indicate optional components (such as fields that may be included based on the specific IEEE 802.11 standard or optional processes in an operation).

The MAC header 202 includes a frame control field 210, a duration/ID field 212, an address 1 field 214, an address 2 field 216, an address 3 field 218, and a sequence control field 220. Based on the IEEE 802.11 standard, the MAC header 202 may also include one or more of an address 4 field 222, a quality of service (QoS) control field 224, and an HT control field 226.

The frame control field 210 includes information regarding the type/subtype of frame and control information, such as the data rate and power management status. As depicted in the example MAC frame 200, the frame control field 210 includes a protocol version field 230 (which may be referred to as a protocol field or a version field), a type field 232, a subtype field 234, a to distribution system (DS) field 236, a from DS field 238, a more fragments (frag) field 240, a retry field 242, a power management (mgmt) field 244, a more data field 246, a protected frame field 248, and an HT control (+HTC) or order field 250.

The protocol field 230 may include two bits to indicate the current protocol version for the MAC frame 200. Typically for a WLAN packet, the two bits are 00. Alternatively, the two bits may be 01 for an IEEE 802.11ah packet.

The type field 232 may include two bits to indicate the type of MAC frame 200 (and thus the type of WLAN packet). For example, the two bits being 00 indicates that the MAC frame is a management frame, the two bits being 01 indicates that the MAC frame is a control frame, and the two bits being 10 indicates that the MAC frame is a data frame.

The subtype field 234 may include four bits to indicate the subtype of MAC frame 200 based on the type of MAC frame 200 indicated in the type field 232. For example, for a MAC frame 200 of a management frame type, the four bits may indicate that the subtype of the MAC frame 200 is one of an association request, an association response, a reassociation request, a reassociation response, a probe request, a probe response, a timing advertisement, a beacon, an announcement traffic indication message (ATIM), a dissociation, an authentication, a deauthentication, an action, or an action no ACK (NACK). For a MAC frame 200 of a control frame type, the four bits may indicate that the subtype of the MAC frame 200 is one of a tame ACK (TACK), a beamforming report poll, a VHT/high efficiency (HE) null data packet (NDP) announcement, a control frame extension, a control frame wrapper, a block ACK (BACK) request (BAR), a BACK, a block ACK (BA), a power save (PS) poll, an RTS, a CTS, an ACK, a contention free (CF) end, or a CF end+CF ACK. For a MAC frame 200 of a data frame type, the four bits may indicate that the subtype of the MAC frame 200 is one of a general data frame, a null frame (thus including no data, which may also be referred to as a null data packet (NDP)), a QoS CF Poll (which includes no data), or a QoS CF ACK+CF Poll (which includes no data).

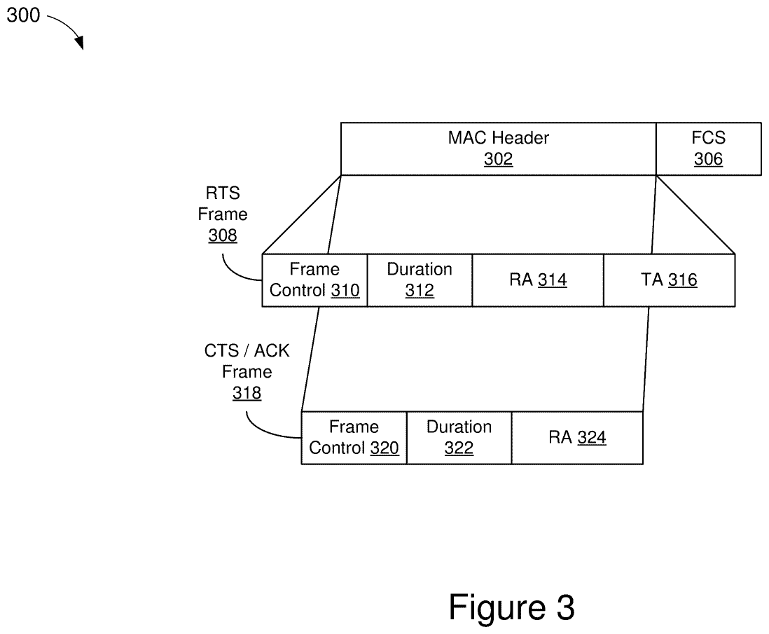

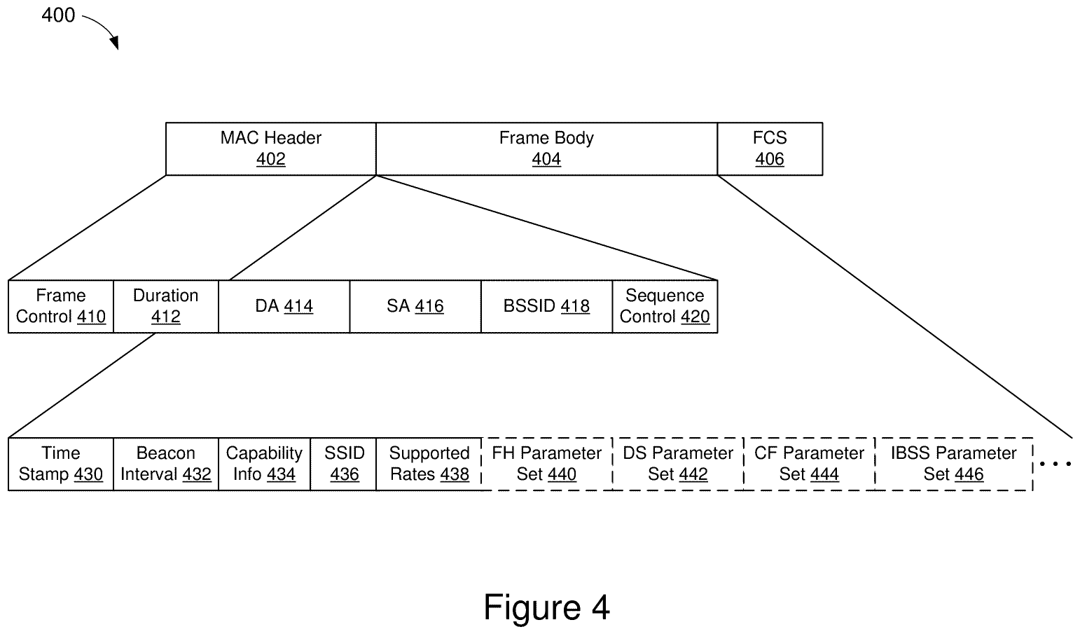

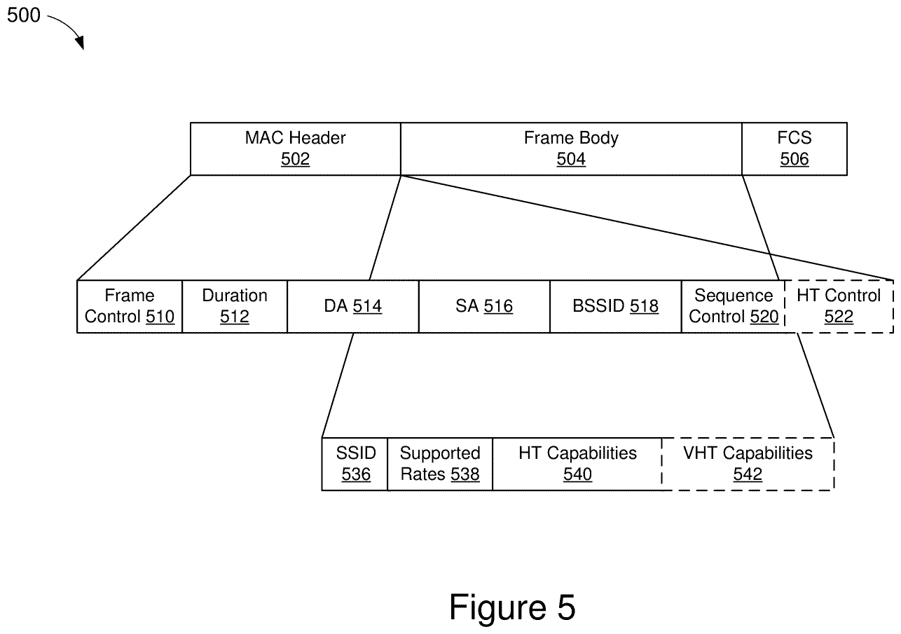

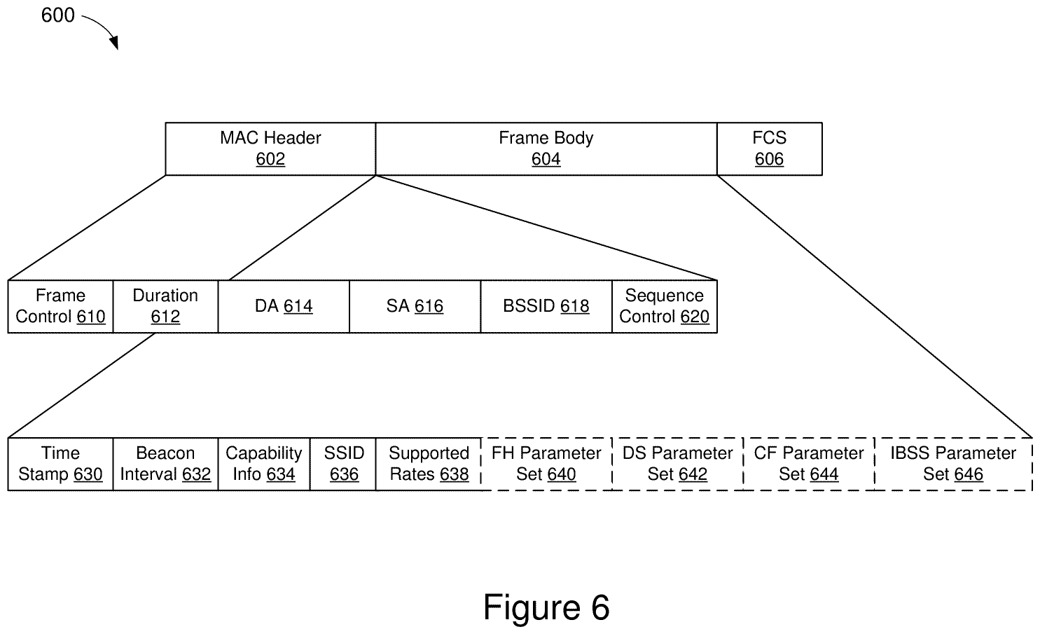

The structure of the MAC frame that the receiving device expects following the type and subtype fields in the MAC frame may be based on the contents of the type and subtype fields. For example, different contents of the type and subtype fields may indicate to the receiving device as to whether the MAC frame is of the format of MAC frame 200, MAC frame 300 (depicted in FIG. 3), MAC frame 400 (depicted in FIG. 4), MAC frame 500 (depicted in FIG. 5, MAC frame 600 (depicted in FIG. 6), or another defined MAC frame format for one of the above listed types and subtypes of MAC frames. The MAC frame 200 is an example general frame format for most frames, with fields including different information based on the type and subtype of MAC frame. For the examples herein, the MAC frame 200 is described with reference to a data frame, with the frame body 204 including data to be processed at a higher layer, but the MAC frame 200 may also be the same format for management or control frames. For the examples, specific example management frame formats are also depicted in FIG. 3 through FIG. 6. To note, FIG. 2 through FIG. 6 depict only some of the example MAC frame formats for clarity in explaining aspects of the present disclosure, but the present disclosure is not limited to the depicted MAC frame formats.

Referring back to FIG. 2, the to DS field 236 and the for DS field 238 may each include one bit to indicate what type of device is indicated in each of the four address fields 214, 216, 218, and optionally 222. For example, the to DS and from DS fields 236 and 238 being 00 may indicate that address 1 214 is to include the address of the destination of the MAC frame 200, that address 2 216 is to include the address of the source of the MAC frame 200, and that address 3 218 is to include the basic service set (BSS) identifier (BSSID) (with address 4 222 not included). The to DS and from DS fields 236 and 238 being 01 may indicate that address 1 214 is to include the address of the destination of the MAC frame 200, that address 2 216 is to include the BSSID, and that address 3 218 is to include the address of the source of the MAC frame 200 (with address 4 222 not included). The to DS and from DS fields 236 and 238 being 10 may indicate that address 1 214 is to include the BSSID, that address 2 216 is to include the address of the source of the MAC frame 200, and that address 3 218 is to include the address of the destination of the MAC frame 200 (with address 4 222 not included). The to DS and from DS fields 236 and 238 being 11 may be for multi-hop communications and indicate that address 1 214 is to include a receiver address, that address 2 216 is to include a transmitter address, that address 3 218 is to include the address of the destination of the MAC frame 200, and that address 4 222 is to include the address of the source of the MAC frame 200.

The more fragments (frag) field 240 may include one bit to indicate whether additional fragments remain to be received. For example, if data to be transmitted via data frames is fragmented and sent as fragments, the transmitting device may indicate if all of the fragments have been sent before and including the current MAC frame 200 by setting the more frag field 240 to 0. If more fragments exist in further MAC frames, the transmitting device may set the more frag field 240 to 1. To note, for non-data frames (such as control or management frames), the more frag field 240 is set to 0.

The retry field 242 may include one bit to indicate whether the receiving device is to request the transmitting device to retry sending the MAC frame 200 if the MAC frame 200 is corrupted (such as the WLAN packet failing the frame check sequence (FCS)). To note, for control frames and management frames, which are not queued for retransmission at a transmitting device, the retry field 242 is set to 0. The power management field 244 may include one bit to indicate the power management state of the transmitting device after the conclusion of the current frame exchange with the receiving device (such as whether the transmitting device is to enter a power save state or is to remain in an active state). The more data field 246 may include one bit to indicate whether additional data is to be transmitted in subsequent MAC frames. To note, additional data is not set for control frames or management frames. As such, the more data field 246 is set to 0 for control frames and management frames to indicate that additional data is not to be sent. The protected frame field 248 may include one bit to indicate whether the MAC frame 200 is encrypted (such as the frame body 204 being encrypted under the wired equivalent privacy (WEP) protocol). To note, control frames and typical management frames are not encrypted. As such, the protected frame field 248 is set to 0 for control frames and management frames to indicate that the MAC frame 200 is not encrypted. For the +HTC/order field 250, if the field 250 is used as an order field, the order field may include one bit to indicate whether MAC frames may be sent out of order (with 1 indicating that MAC frames are sent in order). To note, the bit is set to 0 for control frames and management frames as control frames and management frames do not have an order. If the field 250 is used as a +HTC field, the +HTC field may include one bit to indicate whether the HT control field 226 is used (such as for some BAs).

The duration/ID field 212 may include 16 bits, with the most significant bit (MSB) being the last bit and the least significant bit (LSB) being the first bit. The duration/ID field 212 may indicate different information based on the first one or two MSBs of the field. For example, if the MSB is set to 0, the remaining 15 bits of the field 212 may indicate a network allocation vector (NAV) used for carrier sense multiple access with collision avoidance (CSMA/CA). If the first two MSBs are set to 10, the remaining 14 bits of the field 212 may indicate a duration of time of a contention free (CF) period (CFP) for CSMA/CA during which the wireless channel on which the MAC frame 200 is received is not to be occupied. If the first two MSBs are set to 11, the remaining 14 bits of the field 212 may indicate an association ID (AID) used for the MAC frame 200.

As noted above, the address 1 field 214, address 2 field 216, address 3 field 218, and optionally address 4 field 222 include bits that identify different devices or the BSS based on the to DS and from DS fields 236 and 238.

The sequence control field 220 includes bits that indicate a sequence number assigned to the MAC frame 200. For example, if the data received at the MAC from an upper layer of the transmitting device is more than can fit in MAC frame 200, the transmitting device fragments the data and assigns a sequence number to each fragment to indicate the order of the fragments. In this manner, the receiving device can reconstruct the data by ordering the received fragments based on the sequence number. Otherwise, the sequence control field 220 includes bits that may indicate a sequence of transmission of the frames (such as for control frames or management frames).

The QoS control field 224 is an optional field that exists for data frames that are of the type QoS data (such as for MAC frame 200 with the type and subtype fields 232 and 234 being 10 1000). The QoS control field 224 may include five subfields, a traffic identifier (TID), an end of service period (EOSP), an ACK policy, a reserved bit, and a last field that may indicate one of a transmit (TX) opportunity (TXOP) limit, a TXOP duration, an AP power save (PS) buffer state, or a queue size.

The HT control field 226 is an optional field that may exist for IEEE 802.11n and beyond MAC frames. For example, the HT control field 226 is included in control wrapper frames and in QoS Data and management frames based on the order field 250. The HT control field 226 may include four bytes to indicate control information for HT.

The frame body 204 includes information to be processed by the receiving device. For example, for a data frame, the frame body 204 includes a segment of data to be provided to an upper layer of the receiving device for processing. For a management frame or a control frame, the frame body 204 may include one or more fixed length fields and/or one or more variable length information elements (IEs) for processing (which are referred to in general as fields), such as depicted in FIG. 4 through FIG. 6.

The FCS 206 includes a sequence of bits indicating an FCS number used to perform FCS by the receiving device in order to determine whether the MAC frame 200 (and thus the WLAN packet) is corrupted. The FCS 206 may be two bytes (or four bytes) of bits storing an FCS number generated by the transmitting device applying an FCS algorithm to the content of the remainder of the MAC frame 200. For example, the transmitting device may perform a cyclic redundancy check (CRC) using a defined CRC polynomial to generate the sequence of bits for the FCS 206.

After or while the receiving device receives the WLAN packet and decodes to WLAN packet to obtain the MAC frame 200, the receiving device applies the same FCS algorithm as the transmitting device on the obtained MAC frame 200 to independently generate its own FCS number and compare the generated FCS number to the obtained FCS number in the FCS field 206. If the two FCS numbers are not the same, the receiving device may identify that the MAC frame 200 (and thus the WLAN packet) is corrupted. If the WLAN packet includes multiple MAC frames, the receiving device may determine if one or more MAC frames are corrupted while other MAC frames are not corrupted by performing FCS on each MAC frame. While not depicted in FIG. 1, a PHY envelope of a payload may also include an FCS number such that FCS may be performed on the WLAN packet as a whole at the PHY. As such, as used herein, applying FCS to a WLAN packet may refer to applying FCS to one or more MAC frames or to the WLAN packet as a whole. In addition, identifying that a WLAN packet is corrupted may refer to identifying that one or more MAC frames of a WLAN packet are corrupted based on a MAC frame FCS or identifying that the WLAN packet as a whole is corrupted based on an overall packet FCS.

To note, each of the example MAC frame formats depicted in FIG. 2 through FIG. 6 (as well as the other types of MAC frames not depicted) include an FCS in order for the receiving device to perform FCS. For example, MAC frame 300 in FIG. 3 includes an FCS 306, MAC frame 400 in FIG. 4 includes an FCS 406, MAC frame 500 in FIG. 5 includes an FCS 506, and MAC frame 600 in FIG. 6 includes an FCS 606. In general, each MAC frame includes an FCS in order for FCS to be performed. Specific types of example MAC frames for which an FCS is generated and included in the FCS of the MAC frame are described below with reference to FIG. 3 through FIG. 6.

FIG. 3 shows an example MAC frame format 300 of an RTS frame 308 and a CTS or ACK frame 318 of a WLAN packet. The MAC frame format 300 is referred to herein as MAC frame 300. The MAC frame 300 includes a MAC header 302 and an FCS 306. The MAC frame 300 is an RTS frame 308 if the MAC header 302 includes the frame control field 310, the duration field 312, the receiver address (RA) field 314, and the transmitter address (TA) field 316. The MAC frame 300 is a CTS frame 318 for RTS/CTS signaling if the MAC header 302 includes the frame control field 320, the duration field 322, and the RA field 324. To note, the same format of the MAC frame 300 is also used for an ACK frame 318.

Referring to the RTS frame 308, the frame control field 310 is the same format as the frame control field 210 depicted in FIG. 2 and described above. As such, of the frame control field 310, the protocol field is 00 (to indicate a typical IEEE 802.11 frame), the type field is 10 (to indicate a control frame), and the subtype field is 1101 (to indicate an RTS frame). For the specific type and subtype of MAC frame 300 (i.e., an RTS frame) of the frame control field 310, the to DS field is 0, the from DS field is 0, the more frag field is 0, the retry field 0, the more data field is 0, the protected data field is 0, and the order field is 0.

The duration field 312 indicates a duration to complete the RTS/CTS exchange, as measured in microseconds. The duration is calculated by a transmitting device to cover, e.g., the time to receive a CTS frame and a final ACK frame and the time to transmit a data frame or first fragment of data. In some instances, the duration may be calculated as approximately three short interframe spaces (SIFS) whose length may depend on the specific IEEE 802.11 standard and use (such as 10 or 16 microseconds for each SIFS defined for IEEE 802.11b/g/n packets).

The RA field 314 includes the address of the receiving device for a subsequent data frame or data fragments to be transmitted by the transmitting device. The TA field 316 includes the address of the transmitting device that transmits the RTS frame 308.

Referring to the CTS or ACK frame 318, the frame control field 320 is the same format as the frame control field 210 depicted in FIG. 2 and the frame control field 310 and described above. As such, of the frame control field 320, the protocol field is 00 (to indicate a typical IEEE 802.11 frame), the type field is 10 (to indicate a control frame), and the subtype field is 0011 (to indicate a CTS frame). For the specific type and subtype of MAC frame 300 (i.e., a CTS frame) of the frame control field 310, the to DS field is 0, the from DS field is 0, the more frag field is 0, the retry field 0, the more data field is 0, the protected data field is 0, and the order field is 0 (same as in the RTS frame 308).

For a CTS frame, the duration field 322 includes a duration that is a continuation of the duration in the duration field 312. For example, the WLAN device receiving the RTS frame 308 may subtract the time in microseconds needed for the CTS frame and SIFS prior to the CTS frame from the duration in the duration field 312 to generate the duration included in the duration field 322. For an ACK frame, the duration field 322 may be set to 0s to indicate a duration of zero microseconds. The RA field 324 includes the address of the device that transmitted the RTS frame 308 (for RTS/CTS signaling) or includes the address of the device to receive an ACK frame (such as the transmitting device of a data frame). To note, the WLAN device that receives an RTS frame 308 may copy the address from the TA field 316 to the RA field 324 before transmitting a CTS frame 318.

The FCS 306 of the MAC frame 300 may be the same format as the FCS 206 depicted in FIG. 2 and as described above. As such, a WLAN device receiving a WLAN packet including an RTS frame 308 (referred to as an RTS or RTS packet) or a CTS or ACK frame 318 (referred to as a CTS or CTS packet or an ACK or ACK packet) may perform FCS on the packet as described above.

FIG. 4 shows an example MAC frame format 400 of a beacon frame of a WLAN packet. The MAC frame format 400 is referred to herein as a beacon frame 400. A beacon frame is a periodically broadcasted MAC frame from an AP (such as at a broadcast interval (BI)), with the MAC frame including a BSSID of the BSS for the AP and capabilities of the BSS and AP. The beacon frame 400 includes a MAC header 402, a frame body 404, and an FCS 406.

The MAC header 402 includes a frame control field 410, a duration field 412, a destination address (DA) field 414, a source address (SA) field 416, a BSSID field 418, and a sequence control field 420. The frame control field 410 is the same format as the frame control field 210 depicted in FIG. 2, with the protocol field being set to 00, the type field set to 00 (to indicate a management frame type), the subtype field set to 1000 (to indicate a beacon subtype), the to DS field set to 0, the from DS field set to 0, the more frag field set to 0, the retry field set to 0, the power management field set to 0, the protected field set to 0, and the order field set to 0. The more data field set to 1 may indicate that data is buffered for a STA at the AP. Otherwise, the more data field set to 0 indicates that no data is buffered to the AP for transmitting to a STA. For a beacon frame, the duration field 412 may be set to zeroes to indicate that the duration is 0 microseconds.

For many beacon frames, since a beacon frame is broadcast, the DA field 414 may not include a specific destination address (such as would be required for unicast packets). As such, the DA field 414 may be set to a defined value (such as a binary sequence indicating ff:ff:ff:ff:ff:ff in hexadecimal format). The SA field 416 may include the address of the transmitting device (the AP). The BSSID field 418 may include the ID of the BSS serviced by the AP. As similar to the sequence control field 220 depicted in FIG. 2, the sequence control field 420 includes a sequence of bits that indicates a sequence number associated with the specific beacon frame 400.

As for the frame body 404, since the beacon frame is a management frame and not a data frame, the frame body 404 may include a plurality of defined fields to provide information regarding the AP or the BSS. As used herein, such fields may also be referred to as information elements (IEs). The frame body 404 includes a time stamp field 430, a beacon interval (BI) field 432, a capability information (info) field 434, a service set (SS) identifier (SSID) field 436, and a supported rates field 438. The frame body 404 optionally may also include one or more of a frequency hopping (FH) parameter set field 440 (if frequency hopping spread spectrum (FHSS) is used), a direct sequence (DS) parameter set field 442 (if direct sequence spread spectrum (DSSS) modulation is used), a contention free (CF) parameter set field 444, an independent BSS (IBSS) parameter set field 446, and others as defined in the IEEE 802.11 library of standards for beacon frames. For example, other fields may include a traffic indication map (TIM) to indicate data buffered at the AP for STAs in the network, country, power constraint, channel switch announcement, QoS capability, multiple BSSID, and so on.

The time stamp field 430 indicates a specific time when the beacon frame 400 was transmitted. The time may be used by receiving devices to synchronize the devices in the BSS. With the devices using the indicated time for synchronization, the time stamp field 430 may also be referred to herein as a time synchronization function (TSF) field. The BI field 432 indicates a time interval between beacon frames transmitted by the AP. The capability information field 434 indicates information about the capabilities of the network serviced by the AP, such as security settings and supported data rates. The SSID field 436 indicates the network name that identifies the specific wireless network serviced by the AP. The supported rates field 438 indicates the set of data rates supported for transmission in the wireless network. The FH parameter set field 440 indicates parameters of a wireless network that uses FHSS. The DS parameter set field 442 indicates parameters of a wireless network that uses DSSS, including the wireless channel number used. The CF parameter set field 444 indicates parameters for CF periods in a wireless network. The IBSS parameter set field 446 indicates configuration parameters for a wireless network that is an IBSS.

The FCS 406 of the beacon frame 400 may be the same format as the FCS 206 depicted in FIG. 2 and as described above. As such, a WLAN device receiving a WLAN packet including the beacon frame 400 (referred to as a beacon or a beacon packet) may perform FCS on the packet as described herein.

FIG. 5 shows an example MAC frame format 500 of a probe request frame of a WLAN packet. The MAC frame format 500 is referred to herein as a probe request frame 500. A probe request frame is a management MAC frame broadcast by a transmitting device (such as a STA) to discover nearby networks. A probe request frame may be used to search for a wireless network having a specific name (such as a service set identified by a specific SSID in a frame body of the probe request frame). The probe request frame 500 includes a MAC header 502, a frame body 504, and an FCS 506.

The MAC header 502 includes a frame control field 510, a duration field 512, a DA field 514, an SA field 516, a BSSID field 518, and a sequence control field 520. The MAC header 502 optionally may also include an HT control field 522. The frame control field 510 is the same format as the frame control field 210 depicted in FIG. 2, with the protocol field being set to 00, the type field set to 00 (to indicate a management frame type), the subtype field set to 0100 (to indicate a probe request subtype), the to DS field set to 0, the from DS field set to 0, the more frag field set to 0, the retry field set to 0, the power management field set to 0, the more data field set to 0, the protected field set to 0, and the order field set to 0. For a probe request frame, the duration field 512 may be set to zeroes to indicate that the duration is 0 microseconds.

Similar to beacon frames, since a probe request frame is broadcast, the DA field 514 may not include a specific destination address (such as would be required for unicast packets). As such, the DA field 514 may be set to a defined value (such as a binary sequence indicating ff:ff:ff:ff:ff:ff in hexadecimal format). The SA field 516 may include the address of the transmitting device. The BSSID field 518 may be set to a defined value that does not identify a specific BSSID (such as a binary sequence indicating ff:ff:ff:ff:ff:ff in hexadecimal format). As similar to the sequence control field 220 depicted in FIG. 2, the sequence control field 520 includes a sequence of bits that indicates a sequence number associated with the specific probe request frame 500.

As for the frame body 504, since the probe request frame is a management frame and not a data frame, the frame body 504 may include a plurality of defined fields for the probe request. As used herein, such fields may also be referred to as IEs. The frame body 504 includes an SSID field 536, a supported rates field 538, and an HT capabilities field 540. Based on the IEEE 802.11 standard to which the probe request frame 500 complies, the frame body 504 may also include a very high throughput (VHT) capabilities field 542.

For general network discovery (and thus not searching for a specific SS), the SSID field 536 may include bits that are set to a defined value (such as all zeroes) to indicate that a search is not being performed for a specific network. If the transmitting device is searching for a specific SS, the SSID field 536 may indicate the name (identifier) of the specific SS (such as a binary sequence indicating a 12 value address of the SS in hexadecimal format).

The supported rates field 538 indicates the set of data rates supported by the transmitting device. The HT capabilities field 540 indicates specific capabilities supported by the transmitting device for HT communications. The VHT capabilities field 542 indicates specific capabilities supported by the transmitting device for VHT communications. While not depicted in FIG. 5, other fields may also exist in the frame body 504, such as request information, extended supported rates, DSSS parameter set, 20/40 BSS coexistence, SSID list, channel usage, mesh ID, and so on.

The FCS 506 of the probe request frame 500 may be the same format as the FCS 206 depicted in FIG. 2 and as described above. As such, a WLAN device receiving a WLAN packet including the probe request frame 500 (referred to as a probe request or probe request packet) may perform FCS on the packet as described herein.

FIG. 6 shows an example MAC frame format 600 of a probe response frame of a WLAN packet. The MAC frame format 600 is referred to herein as a probe response frame 600. A probe response frame is a management MAC frame transmitted by a WLAN device that receives a probe request frame (such as an AP that receives probe request frame 500 from a STA). The probe response frame 600 includes a MAC header 602, a frame body 604, and an FCS 606.

The MAC header 602 includes a frame control field 610, a duration field 612, a DA field 614, an SA field 616, a BSSID field 618, and a sequence control field 620. The frame control field 610 is the same format as the frame control field 210 depicted in FIG. 2, with the protocol field being set to 00, the type field set to 00 (to indicate a management frame type), the subtype field set to 0101 (to indicate a probe response subtype), the to DS field set to 0, the from DS field set to 0, the more frag field set to 0, the retry field set to 0, the more data field set to 0, the protected field set to 0, and the order field set to 0. To note, the AP may set the power management field of the frame control field 610 to a desired value based on the power management defined at the AP. For a probe response frame, the duration field 612 may be set by the AP to a value to indicate the duration (in microseconds) that the STA may occupy a wireless channel.

The DA field 614 identifies the destination of the probe response frame as the transmitting device of the probe request frame to which the probe response frame is in response. The AP may copy the content of the SA field 516 from the probe request frame 500 to the DA field 614 of the probe response frame 600 in generating the probe response frame. The SA field 616 may indicate the AP or the BSSID that the AP services, and the BSSID field 618 may identify the BSS that the AP services. For example, the AP may include a sequence of bits that indicates a 12 value address of the BSS in hexadecimal format as defined at the AP in the SA field 616 and the BSSID field 618. Similar to the sequence control field 220 depicted in FIG. 2, the sequence control field 620 includes a sequence of bits that indicates a sequence number associated with the specific probe response frame 600.

As for the frame body 604, since the probe response frame is a management frame and not a data frame, the frame body 604 may include a plurality of defined fields to provide information regarding the AP, BSS, or SS. As used herein, such fields may also be referred to as information elements (IEs). The frame body 604 includes a time stamp field 630, a BI field 632, a capability info field 634, an SSID field 636, and a supported rates field 638. The frame body 604 optionally may also include one or more of an FH parameter set field 640 (if FHSS is used), a DS parameter set field 642 (if DSSS is used), a CF parameter set field 644, and an IBSS parameter set field 646, as well as other fields not depicted in FIG. 6 but may be defined in the IEEE 802.11 library of standards for probe response frames. For example, other fields may include a TIM to indicate data buffered at the AP for STAs in a power save state, country, power constraint, channel switch announcement, QoS capability, multiple BSSID, and so on, similar to a beacon frame. To note, if an AP includes a TIM in the beacon frames, the AP might not include the TIM in probe response frames.

The fields in the frame body 604 of the probe response frame 600 are similar to the fields in the frame body 404 of the beacon frame 400 depicted in FIG. 4. For example, the time stamp field 630 (or TSF field) may be the same as the time stamp field 430 described above, the BI field 632 may be the same as the BI field 432 described above, the capability info field 634 may be the same as the capability info field 434 described above, the SSID field 636 may be the same as the SSID field 436 described above, the supported rates field 638 may be the same as the supported rates field 438 described above, the FH parameter set field 640 may be the same as the FH parameter set field 440 described above, the DS parameter set field 642 may be the same as the DS parameter set field 442 described above, the CF parameter set field 644 may be the same as the CF parameter set field 444 described above, and the IBSS field 646 may be the same as the IBSS field 446 described above, as well as the corresponding fields not depicted in the probe response frame 600 that may also be included in the beacon frame 400 as defined in the IEEE 802.11 library of standards.

The example WLAN packet depicted in FIG. 1 and the example MAC frames depicted in FIG. 2 through FIG. 6 are used in examples herein to describe aspects of the present disclosure, and in particular to replacing a portion of content of a WLAN packet with a defined portion of content at the receiving device. For example, if a WLAN device has defined at the device content including one or more fields of an obtained MAC frame in a received WLAN packet that is identified to be corrupted, the WLAN device may replace the one or more fields of the obtained MAC frame with the defined one or more fields in an attempt to correct the WLAN packet. While some types and subtypes of MAC frames and a WLAN packet are described above for clarity in explaining aspects of the present disclosure, it is to be noted that the present disclosure may apply to any suitable WLAN packet and frame format. An example WLAN device to perform the operations of replacing content of a WLAN packet (such as one or more fields of a MAC frame) as described in the examples herein is depicted in FIG. 7 described below.

FIG. 7 shows a block diagram of an example WLAN device 700, according to some implementations. The WLAN device 700 is configured to replace at least a portion of content of a WLAN packet with defined content at the WLAN device (such as to attempt to correct a corrupted WLAN packet). For example, the WLAN device 700 may be configured to identify that a received WLAN packet is corrupted by performing FCS, replace one or more fields of the MAC frame of the WLAN packet based on the WLAN packet failing FCS to generate a new WLAN packet, and perform FCS on the new WLAN packet. If the new WLAN packet is not corrupted (e.g., passes FCS), the WLAN device 700 is configured to process the new WLAN packet (such as processing the corrected MAC frame) without requiring waiting for a new WLAN packet or requesting a new WLAN packet from the transmitting device.

The WLAN device 700 may be a STA or an AP. A STA may communicate using WLAN packets with an AP, such as in a BSS. A STA may additionally or alternatively communicate using WLAN packets directly with another STA. For example, a STA may communicate with another STA in an ad-hoc network or another type of P2P networks. In some P2P networks, the WLAN device 700 or the other communicating device may be a P2P group owner (P2P GO), which may perform many of the functions typically performed by an AP, such as broadcasting beacons and supporting power save for associated clients (STAs) in the network. An AP may communicate using WLAN packets with a STA, such as in a BSS. An AP may additionally or alternatively communicate using WLAN packets with another AP, such as in a mesh network. The operations described herein may apply to WLAN packets communicated between a STA and an AP, a STA and a STA, or an AP and an AP.

The WLAN device 700 includes a WLAN interface 710, a processing system 720, and a memory 730. The WLAN interface 710 may be coupled to an antenna 716 (which may include one or more antennas) to communicate with one or more other WLAN devices (such as one or more APs and/or one or more STAs). The WLAN interface 710 is to transmit and receive WLAN packets for the WLAN device 700. The WLAN interface 710 includes a radio 712 coupled to the antenna 716 and a modem 714 coupled to the radio 712 and the processing system 720. The radio 712 includes one or more radios to transmit and receive modulated WLAN packets using the antenna 716, with the antenna 716 including one or more antennas for transmitting and/or receiving modulated WLAN packets on one or more wireless channels. Transmitting or receiving a modulated WLAN packet is referred to herein as transmitting or receiving a WLAN packet for simplicity. The modem 714 includes one or more modems to implement a PHY of the WLAN device 700. In some implementations, the modem 714 may also implement a portion of the MAC of the WLAN device 700 (such as a hardware portion of the MAC). For example, the modem 714 is configured to modulate WLAN packets and to output the modulated WLAN packets to the radio 712 for transmission over the wireless medium using the antenna 716. The modem 714 is similarly configured to obtain modulated WLAN packets received by the radio 712 and to demodulate the WLAN packets to provide demodulated WLAN packets. In this manner, the WLAN device 700 may obtain a MAC frame from a received WLAN packet. In addition to a modulator and a demodulator, the modem 714 may further include digital signal processing (DSP) circuitry, automatic gain control (AGC) circuitry, a coder, a decoder, a multiplexer and a demultiplexer. For example, while in a transmission mode, data obtained from the processing system 720 may be provided to an encoder, which encodes the data to provide coded bits. The coded bits may then be mapped to a number of spatial streams for spatial multiplexing or a number of space-time streams for space-time block coding (STBC). The coded bits in the streams may then be mapped to points in a modulation constellation (using a selected modulation and coding scheme (MCS)) to provide modulated symbols. The modulated symbols in the respective spatial or space-time streams may be multiplexed, transformed via an inverse fast Fourier transform (IFFT) block, and subsequently provided to the DSP circuitry (for example, for transmit windowing and filtering). The digital signals may then be provided to a digital-to-analog converter (DAC). The resultant analog signals may then be provided to a frequency upconverter, and ultimately, the radio 712. In implementations involving beamforming, the modulated symbols in the respective spatial streams are precoded via a steering matrix prior to their provision to the IFFT block.

While in a reception mode, the DSP circuitry is configured to acquire a signal including modulated symbols received from the radio 712, for example, by detecting the presence of the signal and estimating the initial timing and frequency offsets. The DSP circuitry is further configured to digitally condition the signal (for example, using channel (narrowband) filtering and analog impairment conditioning and applying a digital gain to obtain a narrowband signal). The output of the DSP circuitry may then be provided to the AGC circuitry, which is configured to use information extracted from the digital signals, for example, in one or more received training fields, to determine an appropriate gain. The output of the DSP circuitry is also coupled with a demultiplexer that demultiplexes the modulated symbols when multiple spatial streams or space-time streams are received. The demultiplexed symbols may be provided to a demodulator, which is configured to extract the symbols from the signal and, for example, compute the logarithm likelihood ratios (LLRs) for each bit position of each subcarrier in each spatial stream. The demodulator is coupled with the decoder, which may be configured to process the LLRs to provide decoded bits. The decoded bits may then be descrambled and provided to the MAC (such as the processing system 720) as one or more MAC frames for processing, evaluation, or interpretation. Processing a WLAN packet may refer herein to operations performed by the processing system 720 (or the modem 712 operating at the MAC) on the WLAN packet (such as processing one or more MAC frames from the WLAN packet at the MAC or processing the payload of the MAC frame at the MAC or a higher layer).

The radio 712 may include at least one radio frequency (RF) transmitter (or “transmitter chain”) and at least one RF receiver (or “receiver chain”), which may be combined into one or more transceivers. For example, each of the RF transmitters and receivers may include various analog circuitry including at least one power amplifier (PA) and at least one low-noise amplifier (LNA), respectively. The RF transmitters and receivers may, in turn, be coupled to the antenna 716. For each, each chain of a transmitter and receiver may be connected to its own antenna if antennas are not to be shared, or a plurality of chains may be coupled to one or more antennas for sharing. The symbols of a WLAN packet output from the modem 714 are provided to the radio 712, which then transmits the symbols of the WLAN packet via the coupled antenna 716. Similarly, symbols of a WLAN packet received via the antenna 716 are obtained by the radio 712, which then provides the symbols to the modem 714.

The memory 730 may include a non-transitory computer-readable medium (including one or more nonvolatile memory elements, such as EPROM, EEPROM, Flash memory, or a hard drive, among other examples) that may store instructions 732 for performing the operations described herein. The memory 730 may also store WLAN packet content 734 that may be used to replace portions of a received WLAN packet. The instructions 732, when executed by the processing system 720, cause the WLAN device 700 to perform the corresponding functions or operations. While the memory 730 is depicted as being coupled to the processing system 720, the memory may additionally or alternatively be coupled to the WLAN interface 710 (such as via a bus).

The processing system 720 may include any suitable one or more processors capable of executing scripts or instructions of one or more software programs stored in the WLAN device 700 (such as in the memory 730). For example, the processing system 720 may execute the instructions 732 to replace the content of at least a portion of a received WLAN packet (such as replacing one or more fields of a MAC frame in the WLAN packet). The processing system 720 may also execute the instructions 732 to identify if a WLAN packet is corrupted and determine whether to correct the WLAN packet, process a corrected WLAN packet, request a new WLAN packet if a corrupted WLAN packet cannot be corrected, or other functions as described herein. In some implementations, the processing system 720 may also include dedicated hardware to perform specific operations.

The processing system 720 processes information received via the WLAN interface 710 that is received by the WLAN interface 710 and processes information to be output via the WLAN interface 710. For example, the processing system 720 may implement a control plane and at least a portion of a MAC of the WLAN device 700 to perform various operations related to the generation, transmission, reception and processing of MAC frames, packets, or other protocol data units (PDUs). In some implementations, the MAC is configured to generate MAC frames (or other PDUs) for provision to the PHY (such as the modem 714) for coding, and to receive decoded information bits from the PHY (such as from the modem 714) for processing as MAC frames (or other PDUs). The MAC (such as the processing system 720) may further be configured to allocate time and frequency resources, such as for orthogonal frequency division multiple access (OFDMA), among other operations. In some implementations, the processing system 720 may generally control the modem 714 to cause the modem 714 to perform various operations described herein. As used herein, WLAN device 700 processing a WLAN packet may refer to the processing system 720 processing content of the WLAN packet (such as content of a frame body of a MAC frame in the WLAN packet) at the MAC or a higher layer of the WLAN device 700.

Referring to the WLAN packet content 734 used to replace content in a WLAN packet (such as one or more fields in a MAC frame), the memory 730 may store the content 734 in any suitable manner. For example, the memory 730 may store a table of fields of a MAC frame that may be replaced and the content of those fields to be used in replacing those fields. The table may be organized based on the type and subtype of the MAC frame included in the WLAN packet (such as each row corresponding to a type and subtype combination). The table may also be organized based on a source/transmitting device address for a previously received WLAN packet (such as each row for a type and subtype combination also corresponding to a specific device address). The columns may thus be the different types of defined fields across the different MAC frames (which may include MAC header fields and frame body fields). For each cell, a defined cell value not used in any of the fields may indicate that the corresponding MAC frame field is not to be replaced. Otherwise, a different cell value may indicate that the corresponding MAC frame field is to be replaced with the cell value.

In some implementations, the table or other object (which is referred to generally as one or more stored WLAN packets) may be organized relationally and thus capable of presenting information as data sets in tabular form and capable of manipulating the data sets using relational operators. A Structured Query Language (SQL) or other suitable instructions for querying and maintaining the stored WLAN packets may be used in order to retrieve desired content for replacement as well as update the stored WLAN packets for future use.

In another example, the memory 730 may store a mask for each template MAC frame based on type and subtype combination (and potentially a source address of a previously received WLAN packet). The mask may include static field values in the places within the WLAN packet (such as within a MAC frame) that the obtained content of the received WLAN packet is to be replaced, and the mask may include holes when the content of the received WLAN packet is not to be replaced. To note, the memory 730 may store any number of masks, tables, or other objects of WLAN packet content 734 in any suitable format (with the object including the content used for replacement for a received WLAN packet being referred to herein as a stored WLAN packet (or template WLAN packet)). As such, the memory 730 may include any number of stored WLAN packets for use in replacing content of received WLAN packets, which may be based on a combination of type, subtype of a MAC frame and/or a source of the received WLAN packet. With the WLAN packet content 734 organized in the memory 730 for access by the processing system 720, the processing system 720 may query the memory 730 to search for and retrieve the content (such as table cell values, in a mask including the content used for replacement, etc.) that is to be inserted into a received WLAN packet based on the fields to be replaced in the received WLAN packet.

In some implementations, the WLAN device 700 may have defined the fields that may be replaced for different types of WLAN packets (such as for different type and subtype MAC frames). For example, the fields that may be replaced in an obtained WLAN packet may be defined in a table or other object indicating the fields to be replaced for the specific type and subtype of the WLAN packet, such as by the cells in the table corresponding to fields that may be replaced not being set to the defined value used for indicating that the corresponding field is not to be replaced. In this manner, if different content is to be replaced in a specific obtained WLAN packet, the stored WLAN packet in memory 730 may be updated to reflect such changes.

The WLAN device 700 may obtain or generate the WLAN packet content 734 (such as the one or more stored WLAN packets) to be stored in the memory 730 using one or more means. In some implementations, the WLAN device 700 may obtain content (such as content for specific fields of different MAC frames) from specific device settings. For example, for a data frame or other types of MAC frames, the destination or receiver address of a data frame may be the address coded to the WLAN device 700. In addition, other fields may be fixed based on the specific type or subtype of the MAC frame, such as one or more of fields 236-250 being specific values based on a MAC frame being a control frame or a specific subtype of management frame (such as a beacon frame or a probe request or response frame). Further, one or more fields may be fixed based on a connection or association with another wireless device. For example, a source or transmitter address may be the address of the wireless device (or a BSSID) associated with or communicably connected to the WLAN device 700. Similarly, the BSSID and the SSID may be known based on the current or previous connection or association. Further, security settings, the wireless channel being used, etc., may be known based on the settings for a connection with another wireless device (such as an AP).

In some implementations, the WLAN device 700 may obtain content from one or more previously received or transmitted WLAN packets. For example, if the received WLAN packet is a probe response, one or more fields from a previously sent probe request may be used, such as the SSID if a specific SSID is being searched for, the duration, a sequence control, or HT capabilities.

For various types and subtypes of MAC frames, such as data frames and different management frames, one or more fields may be used by the WLAN device 700 from a previously received beacon frame, such as a source address, a BSSID, supported rates, and so on. Similarly, one or more fields may be used from a previously received probe response frame (which was transmitted in response to a probe request transmitted by the WLAN device 700). As such, the WLAN device 700 may generate a stored WLAN packet from one of a beacon frame previously broadcast by a transmitting device (AP) or a probe response frame previously transmitted by the transmitting device in response to receiving a probe request frame from the WLAN device 700. To note, other types/subtypes of frames may be used to generate the stored WLAN packet, such as other management frames, control frames, or data frames.

When WLAN packets that are not corrupted are received or when settings are changed at the WLAN device 700 (such as when connecting to a new AP servicing a new BSSID), the wireless device 700 may identify if the relevant stored WLAN packets are up to date and update the relevant stored WLAN packets to include any updated content. For example, when a STA associates with a new AP, the STA may update the stored WLAN packets for the different frames using the new AP address, BSSID, security settings, and other information that can be replaced in a received WLAN packet. In this manner, the WLAN packet content 734 remains up to date during operation of the WLAN device 700.

In this manner, the WLAN device 700 may populate the WLAN packet content 734. In some implementations, the WLAN device 700 may ensure that portions of the WLAN packet content 734 do not become stale. For example, for a table used to organize MAC frame fields and their content for replacement for different types and subtypes of MAC frames, the WLAN device 700 may track the cells that are updated based on previously received frames and track the amount of time that passes that a cell is not verified or updated based on a newly received frame. If the time becomes greater than a threshold amount of time, the cell may be cleared to ensure stale content is not used in the replacement process. Similar steps to ensure freshness of content may also be performed for a mask or other objects that may comprise the stored WLAN packets.

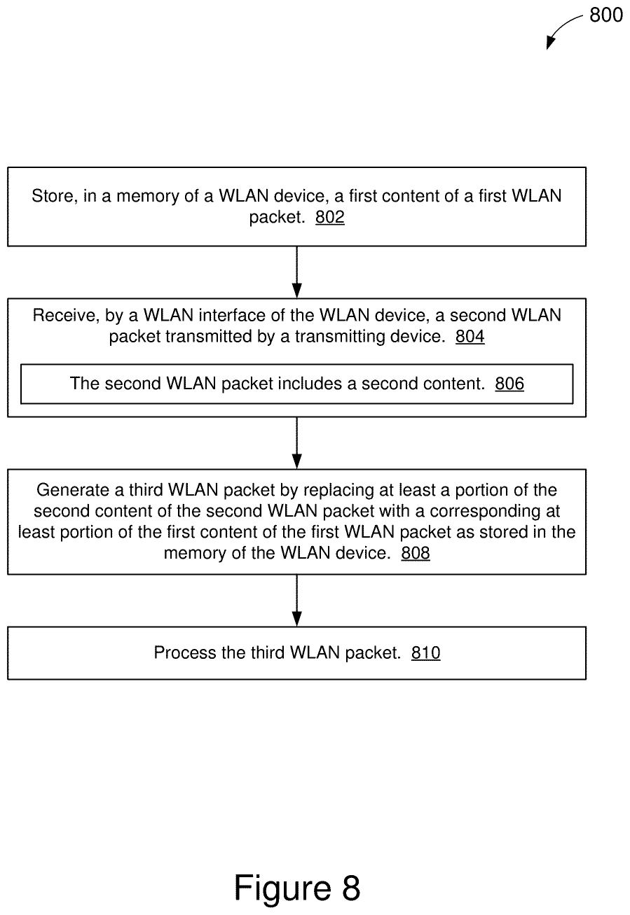

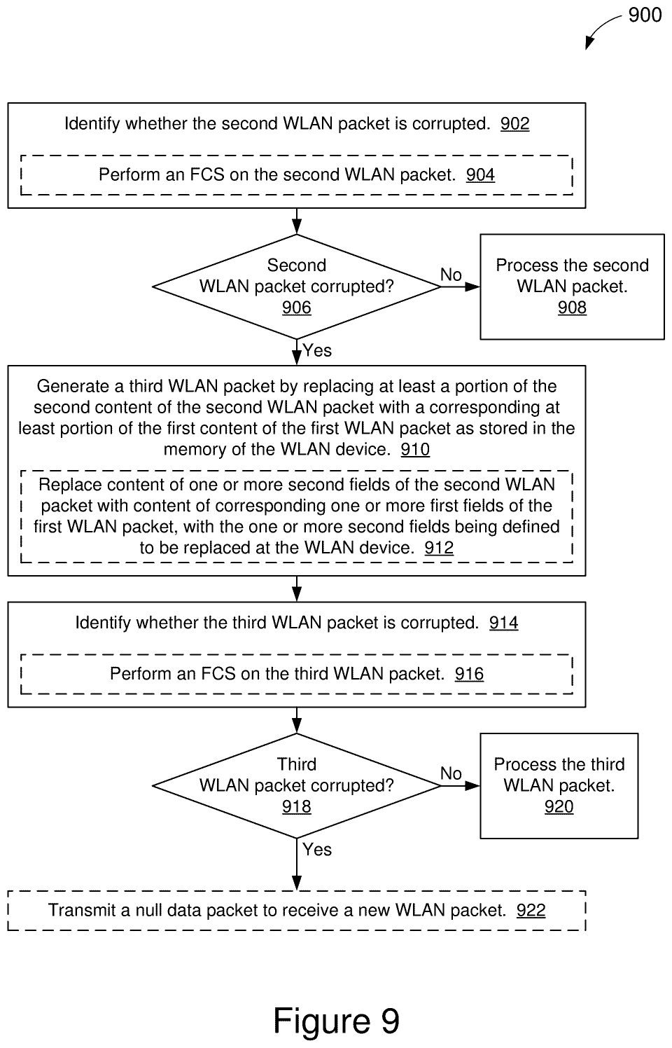

With the WLAN packet content 734 stored in memory 730 (such as one or more stored WLAN packets being included in memory), the WLAN device 700 may replace content of at least a portion of a received WLAN packet. In some implementations, the WLAN device 700 may first identify if a received WLAN packet is corrupted before replacing content in the received WLAN packet. For example, the WLAN device 700 may perform FCS on the WLAN packet (such as comparing the FCS number in the MAC frame to a generated FCS number by performing CRC on the MAC frame to determine if the two numbers are equal) to identify if a received WLAN packet is corrupted. If the received WLAN packet is corrupted, the WLAN device 700 may then replace portions of the received WLAN packet with content from a stored WLAN packet in the memory 730. Alternatively, the WLAN device 700 may identify a stored WLAN packet in memory 730 corresponding to each received WLAN packet and automatically replace the designated content in the received WLAN packet using the stored WLAN packet (thus without identify first if the received WLAN packet is corrupted). Example operations for performing content replacement and when to perform content replacement are described below with reference to FIG. 8 and FIG. 9.

FIG. 8 shows an illustrative flowchart depicting an example operation 800 for replacing a portion of a WLAN packet, according to some implementations. The example operation 800 may be performed by a WLAN device to attempt to correct corrupted WLAN packets or to otherwise adjust received WLAN packets. Operation 800 is described below as being performed by the WLAN device 700 depicted in FIG. 7 for clarity.

The WLAN device 700 stores, in a memory 730 of the WLAN device 700, a first content of a first WLAN packet (802). For example, the memory 730 may store the WLAN packet content 734 for different types of WLAN packets (such as different types and subtypes of MAC frames in the WLAN packets), with the WLAN packet content 734 including the stored WLAN packets including the first WLAN packet (such as a table, mask, or other object that includes the values to be inserted into a received WLAN packet at defined locations, such as specific fields of a MAC frame). As noted above, the WLAN device 700 may generate the first content in any suitable manner, such as from previously received frames, device settings, connection settings, or information regarding an associated or connected device.

With the first content stored in the memory 730, the WLAN device 700 receives, by the WLAN interface 710 of the WLAN device 700, a second WLAN packet transmitted by a transmitting device (804). For example, the radio 712 may receive a modulated WLAN packet 100 using the antenna 716, and the modem may demodulate (and perform other operations on) the modulated WLAN packet 100 to obtain the payload 104 that includes one or more MAC frames (such as a MAC frame 200) or other PDUs. The MAC frame 200 is provided to the processing system 720 for operations to be performed at the MAC of the WLAN device 700.

The second WLAN packet includes a second content (806). In some implementations, the second content is the content that may be replaced in the second WLAN packet, such as one or more fields of MAC frame 200 or other MAC frame in the second WLAN packet. For example, the second content may include one or more of at least a portion of fields 236-250 of the frame control field 210, duration/ID field 212, address 1 field 214 (which may be a source or destination address), address 2 field 216 (which may be a source, destination, or BSSID), address 3 field 218 (which may be an address or BSSID), or sequence control field 220 of the MAC header 202 of the MAC frame 200.

For an RTS frame 308, the second content may include one or more of a portion of the frame control field 310, the RA field 314, or the TA field 316 of the MAC header 302. For a CTS or ACK frame 318, the second content may include one or more of a portion of the frame control field 320, the duration field 322, or the RA field 324. For a beacon frame 400, the second content may include one or more of a portion of the frame control field 410, duration field 412, DA field 414, SA field 416, BSSID field 418, or sequence control field 420 of the MAC header 402. Similarly for a probe request frame 500, the second content may include one or more of fields 510-522 of the MAC header 502, and for a probe response frame 600, the second content may include one or more of fields 610-620 of the MAC header 602. For some management or control MAC frames, the second content may include one or more fields in the frame body of the MAC frame. For example, for a beacon frame 400, the second content may include one or more of BI field 432, capability info field 434, SSID field 436, supported rates 438, or one or more of the other fields in the frame body 404. For a probe request frame 500, the second content may include one or more of an SSID field 536, a supported rates field 538, an HT capabilities field 540, or optionally a VHT capabilities field 542 in the frame body 504. For a probe response frame 600, the second content may include one or more of fields 632 and beyond in the frame body 604, such as the wireless channel or other information.

The second content of the second WLAN packet is the content defined at the WLAN device 700 as able to be replaced using the first content. For example, the first content includes field content that corresponds to one or more fields in a received MAC frame in the second WLAN packet. As noted above, the first content may depend on the type of WLAN packet, such as the type and subtype of the MAC frame in the second WLAN packet. The first content may also depend on the transmitting device, which may be identified using a source or transmitting address in the MAC frame of the second WLAN packet. As such, the second content may include the fields that correspond to the fields identified as being able to be replaced based on the first WLAN packet (such as the corresponding fields identified in a table or a mask stored in the memory 730).

In some implementations, the first content is included in a mask corresponding to the specific type and subtype of the second WLAN packet (the MAC frame in the second WLAN packet), and the mask may be the first WLAN packet. As such, the memory 730 may store a plurality of masks, with each mask corresponding to a specific type and subtype combination from the type and subtype fields of a MAC frame. In this manner, each type and subtype of MAC frame includes a corresponding mask in memory 730. The processing system 720 reads the type and subtype field of the MAC frame, and the processing system 720 is thus able to retrieve the relevant mask from the memory 730 based on the content of the type and type field. Similar operations may also be performed with a table, with each row corresponding to a specific type and subtype value from the type and subtype fields. The processing system 720 may retrieve the relevant content from the table row corresponding to the type and subtype values in the received MAC frame. As noted herein, one or more masks or a table or other suitable objects for organizing the content is referred to herein as one or more stored WLAN packets (which includes the first (stored) WLAN packet that corresponds to the second (received) WLAN packet).

As noted above, a first WLAN packet may be generated by various means, including from previously obtained frames. For example, if the wireless device 700 is a STA connected to an AP, the wireless device 700 periodically receives beacon frames broadcast by the AP. The WLAN device 700 may use fields from a previously broadcast beacon frame for the first content. For example, one or more fields may be used to attempt to correct a later beacon frame that is corrupted. One or more fields may also be used to attempt to correct a data frame or other type of management frame. For example, the first WLAN packet may include the address fields and the BSSID field of the beacon frame as one or more of the address fields in a data frame or other management frames (depending on to which type of frame the first WLAN packet corresponds). In addition, various frames of the frame control field or from a frame body may also be obtained from the previously received beacon frame and included in the first WLAN packet. As such, the first WLAN packet may be generated (such as a table row populated or a mask generated) from a previously broadcast beacon frame from the AP. Similarly, the first WLAN packet may be generated from a probe response frame previously transmitted by the AP in response to receiving a probe request frame from the WLAN device 700. For example, in comparing the beacon frame 400 with the probe response frame 600, many of the fields are the same between the frames. As such, the WLAN device 700 may generate the first WLAN packet from a probe response frame in a similar manner as generating the first WLAN packet from a beacon frame.

Referring back to FIG. 8, the WLAN device 700 generates a third WLAN packet by replacing at least a portion of the second content of the second WLAN packet with a corresponding at least portion of the first content of the first WLAN packet as stored in the memory 730 of the WLAN device 700 (808). In some implementations, the processing system 720 operates on a MAC frame in the second WLAN packet at the MAC in order to generate the third WLAN packet. As such, replacing at least the portion of the second content of the second WLAN packet with the corresponding at least portion of the first content of the first WLAN packet may include replacing content of one or more second fields of the second WLAN packet with content of corresponding one or more first fields of the first WLAN packet, with the one or more second fields being defined to be replaced at the WLAN device. For example, the processing system 720 reads the protocol field, the type field, and the subtype field of the MAC header to identify the type and subtype of the MAC frame. The processing system 720 may then query the memory 730 to retrieve the first WLAN packet from the WLAN packet content 734 based on the type and subtype of the first WLAN packet matching the type and subtype of the second WLAN packet. For example, the processing system 720 may retrieve a mask that is associated with the type and subtype of the second WLAN packet, or the processing system 720 may retrieve defined fields from a table row corresponding to the type and subtype. The processing system 720 may then replace at least a portion of the second content by, e.g., applying the mask to adjust one or more fields to a defined value for the MAC frame or replacing the defined fields in the MAC frame with the retrieved fields from memory 730. To note, the WLAN device 700 is able to identify the locations of the fields in a MAC frame (or otherwise in a WLAN packet) based on the locations and lengths of the fields being defined at the bit level in the IEEE 802.11 family of standards. As such, replacing a field may include replacing a defined length of bits starting at a defined bit location in the MAC frame.

The third WLAN packet is the second WLAN packet with the at least portion of the second content replaced. With the third WLAN packet generated, the WLAN device 700 (such as the processing system 720) processes the third WLAN packet. For example, if the third WLAN packet is not corrupted, the processing system 720 may obtain and process the frame body of the adjusted MAC frame. If the MAC frame is a data frame, the data may be provided to a higher layer (such as an application layer or another suitable layer) for processing by the WLAN device 700.

Even if the third WLAN packet is corrupted, the WLAN device 700 may process portions of the third WLAN packet. In some implementations, the WLAN device 700 may process one or more of a TIM field or a TSF field of the third WLAN packet. For example, if the WLAN device 700 is a STA and the transmitting device is an AP, the second WLAN packet may include a beacon frame broadcast by the AP (such as beacon frame 400). The beacon frame includes a TIM to indicate that data is queued at the AP for the connected STAs and includes a TSF for the connected STAs to synchronize with the AP. As such, the WLAN device 700 may process the TSF field (such as the time stamp field 430 of beacon frame 400) for performing time synchronization functions to ensure the connection with the AP remains stable. The WLAN device 700 may additionally or alternatively process a TIM field (such as in the frame body 404 of beacon frame 400) to identify if the AP has data queued for transmission and the WLAN device 700 is to remain in an active state to receive data or the WLAN device 700 is to query the AP for the data.

As noted above, replacing at least a portion of the second content of the second WLAN packet may be based on the WLAN device 700 identifying that the received WLAN packet is corrupted. As such, the WLAN device 700 may identify whether the second WLAN packet is corrupted, with generating the third WLAN packet being based on identifying that the second WLAN packet is corrupted. In some implementations, identifying whether the second WLAN packet is corrupted includes performing an FCS on the second WLAN packet. For example, for a MAC frame 200, the processing system 720 may perform an FCS by calculating a running checksum by applying a CRC polynomial to the content of the MAC frame 200. The processing system 720 then compares the final checksum (obtained FCS number) to the FCS number included in the FCS 206. If the FCS numbers match, the WLAN device 700 does not identify the WLAN packet as corrupted. If the FCS numbers do not match, the WLAN device 700 identifies the WLAN as corrupted.

Similarly, the WLAN device 700 may identify whether the third WLAN packet is corrupted before processing the third WLAN packet. In some implementations, the processing system 720 may perform FCS on the third WLAN packet, with processing the third WLAN packet being based on the third WLAN packet passing the FCS performed on the third WLAN packet. For example, the processing system 720 may perform FCS on the updated MAC frame by generating a checksum by applying the CRC polynomial to the updated MAC frame and comparing the checksum to the FCS number in the FCS of the updated MAC frame. To note, in updating the MAC frame (or the WLAN packet in general), an FCS of the WLAN packet (such as of the MAC frame) is not modified. As noted above, if the checksum matches the FCS number, the WLAN device 700 does not identify the third WLAN packet as corrupted. While performing FCS is described in the examples as being performed at the MAC for a MAC frame, in some implementations, FCS may also be performed at the PHY, with replacements to the second WLAN packet also occurring at the PHY (such as by the modem 714).

FIG. 9 shows an illustrative flowchart depicting an example operation 900 for identifying and correcting a corrupted WLAN packet, according to some implementations. The example operation 900 may be an example implementation of block 808 of operation 800, and as such may be performed in conjunction with example operation 800. Operation 900 is described below as being performed by the WLAN device 700 depicted in FIG. 7 for clarity.

With the second WLAN packet received, the WLAN device 700 identifies whether the second WLAN packet is corrupted (902). In some implementations, the WLAN device 700 performs FCS on the second WLAN packet (904). For example, the WLAN device 700 may perform FCS on a received MAC frame in the second WLAN packet to identify whether the second WLAN packet (such as the received MAC frame) is corrupted.

If the second WLAN packet is not corrupted (906), the WLAN device 700 processes the second WLAN packet (908). For example, if the MAC frame passes FCS, the processing system 720 may process the MAC frame, including processing the frame body of the MAC frame (which may include processing data in the frame body at a higher layer of the WLAN device 700). If the second WLAN packet is corrupted (906), the WLAN device 700 generates a third WLAN packet by replacing at least a portion of the second content of the second WLAN packet with a corresponding at least portion of the first content of the first WLAN packet as stored in the memory of the WLAN device (910). The operations for generating the third WLAN packet may be as described above with reference to block 808 of operation 800. In some implementations, generating the third WLAN packet includes replacing content of one or more second fields of the second WLAN packet with content of corresponding one or more first fields of the first WLAN packet, with the one or more second fields being defined to be replaced at the WLAN device 700 (912).

With the third WLAN packet generated, the WLAN device 700 identifies whether the third WLAN packet is corrupted (914). The operations for identifying whether the third WLAN packet is corrupted is the same as the operations for identifying whether the second WLAN packet is corrupted in block 902. In some implementations, the WLAN device 700 performs an FCS on the third WLAN packet (916). If the third WLAN packet is not corrupted (918), the WLAN device 700 processes the third WLAN packet (920). For example, if the adjusted MAC frame passes FCS, the processing system 720 may process the adjusted MAC frame, including processing the frame body of the adjusted MAC frame (which may include processing data in the frame body at a higher layer of the WLAN device 700).

If the third WLAN packet is corrupted (918), the WLAN device 700 may not process the third WLAN packet. For example, the WLAN device 700 may discard the second and third WLAN packets. If the second WLAN packet includes one or more data frames, the WLAN device 700 does not transmit an ACK to the transmitting device, and the transmitting device retransmits the WLAN packet with the one or more data frames to the WLAN device 700. If one PDU of a plurality of PDUs in a WLAN packet is corrupted, the WLAN device 700 may send an ACK for the other PDUs or a not ACK (NACK) for the corrupted PDU so that the transmitting device transmits a new WLAN packet with the corrupted PDU. In some implementations, the WLAN device 700 may remain in an active state in order to sense and receive a new WLAN packet.

If the corrupted WLAN packet includes a beacon frame (or a probe response frame), the WLAN device 700 may process one or more of the TIM field or the TSF field of the frame (such as described above). Otherwise, the WLAN device 700 may discard the WLAN packet. In some implementations of processing the TIM field, the WLAN device 700 may identify whether the AssociationID (AID) is set in the TIM field in order to determine whether to transmit a null data packet (NDP) to the transmitting device for future corrupted WLAN packets.

In some implementations, the WLAN device 700 may transmit a null data packet (NDP) to receive a new WLAN packet (922). For example, the WLAN device 700 (a STA) transmits an NDP to the transmitting device (an AP) to receive a new WLAN packet from the AP based on identifying that the third WLAN packet is corrupted. Transmitting the NDP is based on the AssociationID (AID) being set in the TIM field of a previously received frame from the AP (such as a beacon frame). As such, the AP receiving the NDP may trigger the AP to resend the WLAN packet to the STA. In some implementations, the previously received beacon frame may be corrupted but with the AID set so that the WLAN device 700 may transmit the NDP based on the set AID in the TIM field.

If the second WLAN packet that is corrupted includes a beacon frame, the third WLAN packet remains corrupted, and the AID is set in the TIM of the beacon frame, in some implementations, the WLAN device 700 may operate as normal, such as entering a power save (sleep) state, which may be for a time indicated by a delivery TIM (DTIM) sequence in the WLAN packet. With the BI remaining the same, the WLAN device 700 may wake for the next beacon frame.

In performing the operations described above, a WLAN device may reduce consumption of processing resources and time in communicating with other devices by attempting to correct corrupted WLAN packets before discarding such packets. Consumption of time and processing resources may also be reduced at a transmitting device that is not required to retransmit WLAN packets. As such, operation of a wireless network, including the WLAN device, may be improved based on the implementations described herein.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the disclosure.

The methods, sequences or algorithms described in connection with the aspects disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor.

In the foregoing specification, embodiments have been described with reference to specific examples thereof. It will, however, be evident that various modifications and changes may be made thereto without departing from the broader scope of the disclosure as set forth in the appended claims. The specification and drawings are, accordingly, to be regarded in an illustrative sense rather than a restrictive sense.

What is claimed is:

1. A method performed by a wireless local area network (WLAN) device, the method comprising:
storing, in a memory of a WLAN device, a first content of a first WLAN packet;
receiving, by a WLAN interface of the WLAN device, a second WLAN packet transmitted by a transmitting device, wherein the second WLAN packet includes a second content;
generating a third WLAN packet by replacing at least a portion of the second content of the second WLAN packet with a corresponding at least portion of the first content of the first WLAN packet as stored in the memory of the WLAN device; and
processing the third WLAN packet.

2. The method of claim 1, wherein replacing at least the portion of the second content of the second WLAN packet with the corresponding at least portion of the first content of the first WLAN packet includes replacing content of one or more second fields of the second WLAN packet with content of corresponding one or more first fields of the first WLAN packet, wherein the one or more second fields are defined to be replaced at the WLAN device.

3. The method of claim 2, further comprising identifying, by the WLAN device, whether the second WLAN packet is corrupted, wherein generating the third WLAN packet is based on identifying that the second WLAN packet is corrupted.

4. The method of claim 3, wherein identifying whether the second WLAN packet is corrupted includes performing a frame check sequence (FCS) on the second WLAN packet.

5. The method of claim 4, further comprising performing FCS on the third WLAN packet, wherein processing the third WLAN packet is based on the third WLAN packet passing the FCS performed on the third WLAN packet.

6. The method of claim 2, wherein:
the WLAN device is a station (STA); and
the transmitting device is an access point (AP) communicably coupled to the STA.

7. The method of claim 6, wherein:
processing the third WLAN packet includes processing one or more of a traffic indication map (TIM) field or a time synchronization function (TSF) field of the third WLAN packet.

8. The method of claim 6, further comprising:
identifying, by the STA, that the third WLAN packet is corrupted;
transmitting, by the STA, a null data packet to the AP to receive a new WLAN packet from the AP based on identifying that the third WLAN packet is corrupted, wherein transmitting the null data packet by the STA is based on an AssociationID (AID) being set in the TIM field of a previously received beacon frame from the AP.

9. The method of claim 2, wherein the second WLAN packet is a data packet unicast from the transmitting device to the WLAN device.

10. The method of claim 2, wherein the first WLAN packet is generated from one of:
a beacon frame previously broadcast by the transmitting device; or
a probe response frame previously transmitted by the transmitting device in response to receiving a probe request frame from the WLAN device.

11. A wireless local area network (WLAN) device, comprising:
a WLAN interface;
a processing system; and
a memory storing instructions that when executed by the processing system cause the WLAN device to perform operations comprising:
storing, in the memory, a first content of a first WLAN packet;
receiving, by the WLAN interface, a second WLAN packet transmitted by a transmitting device, wherein the second WLAN packet includes a second content;
generating a third WLAN packet by replacing at least a portion of the second content of the second WLAN packet with a corresponding at least portion of the first content of the first WLAN packet as stored in the memory of the WLAN device; and
processing the third WLAN packet.

12. The WLAN device of claim 11, wherein replacing at least the portion of the second content of the second WLAN packet with the corresponding at least portion of the first content of the first WLAN packet includes replacing content of one or more second fields of the second WLAN packet with content of corresponding one or more first fields of the first WLAN packet, wherein the one or more second fields are defined to be replaced at the WLAN device.

13. The WLAN device of claim 12, wherein the operations further comprise identifying whether the second WLAN packet is corrupted, wherein generating the third WLAN packet is based on identifying that the second WLAN packet is corrupted.

14. The WLAN device of claim 13, wherein identifying whether the second WLAN packet is corrupted includes performing a frame check sequence (FCS) on the second WLAN packet.

15. The WLAN device of claim 14, wherein the operations further comprise performing FCS on the third WLAN packet, wherein processing the third WLAN packet is based on the third WLAN packet passing the FCS performed on the third WLAN packet.

16. The WLAN device of claim 12, wherein:
the WLAN device is a station (STA); and
the transmitting device is an access point (AP) communicably coupled to the STA.

17. The WLAN device of claim 16, wherein:
processing the third WLAN packet includes processing one or more of a traffic indication map (TIM) field or a time synchronization function (TSF) field of the third WLAN packet.

18. The WLAN device of claim 16, wherein the operations further comprise:
identifying, by the STA, that the third WLAN packet is corrupted;
transmitting, by the STA, a null data packet to the AP to receive a new WLAN packet from the AP based on identifying that the third WLAN packet is corrupted, wherein transmitting the null data packet by the STA is based on an AssociationID (AID) being set in the TIM field of a previously received beacon frame from the AP.

19. The WLAN device of claim 12, wherein the second WLAN packet is a data packet unicast from the transmitting device to the WLAN device.

20. The WLAN device of claim 12, wherein the first WLAN packet is generated from one of:
a beacon frame previously broadcast by the transmitting device; or
a probe response frame previously transmitted by the transmitting device in response to receiving a probe request frame from the WLAN device.
